(19) United States
(12) Patent Application Publication
(10) Pub. No.: US 2007/0083737 A1
(43) Pub. Date: Apr. 12, 2007

(54) Processor with efficient shift/rotate instruction execution

(75) Inventor: Douglas H. Bradley, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/204,406

(22) Filed: Aug. 16, 2005

(51) Int. Cl. G06F 9/40

(52) U.S. Cl. 712/226; 712/209

(57) ABSTRACT

A processor is disclosed that efficiently executes shift/rotate instructions. The processor determines if each shift/rotate instruction in an instruction stream is an immediate shift/rotate instruction or a register dependent shift/rotate instruction. If the processor determines that a particular shift/rotate instruction is an immediate shift/rotate instruction, then the processor sends the instruction to a shift/rotate functional unit for immediate execution. However, if the processor determines that a particular shift/rotate instruction is a register dependent shift/rotate instruction, then the processor breaks that instruction into two substitute instructions. A first substitute instruction loads a shift amount from a register file register into a shift amount register in the shift/rotate functional unit. A second substitute instruction performs a data shift specified by the data shift amount that the shift amount register stores.

### TECHNICAL FIELD OF THE INVENTION

The disclosures herein relate generally to processors, and more particularly, to speeding up the execution of shift/rotate instructions in processors.

### BACKGROUND

Processors execute software programs that include a series of instructions. Typical instructions include an opcode and one or more operands. An opcode tells the processor to perform a particular function such as LOAD, STORE, ADD, PUSH, POP and SHIFT/ROTATE. The operand tells the processor on which object or objects to carry out the function that the opcode specifies.

Shift instructions instruct the processor to shift an operand in a data field by a specified amount either to the left or to the right. For example, a shift right instruction instructs the processor to move a quantity in a data field by a shift amount of 1 bit to the right. Another shift instruction may instruct the processor to move a quantity in a data field by a shift amount of 3 bits to the left. The processor fills with zeros, or other data, those bits within the data field that become empty as a result of a simple shift operation. Rotate instructions are a special type of shift instruction that instructs the processor to shift data within the data field. However, with rotate instructions, the processor performs a wraparound operation such that data that falls off one end of the data field as a result of the shift rotates back to the other end of the data field.

Modern processors utilize the technique of pipelining to divide each instruction of a program into a series of smaller steps. By using pipelining, the processor performs the steps in parallel with other steps to increase the effective execution speed of the processor. A typical pipeline for processing a shift/rotate instruction includes the stages shown in TABLE 1 below:

TABLE 1

| Pipeline Stage | Action |
|---|---|
| ISS | Receive Instruction (issue) |
| RF | Read operands from register file |
| EX | Decode shift amount; perform shift (execute) |
| WB | Result available (write back) |

In this conventional pipelining technique, an execution unit in the processor receives a shift/rotate instruction to execute, as TABLE 1 indicates above in the ISS or issue stage. Next, in a register file (RF) stage, the processor reads operands for the shift/rotate instruction from a register file. In the following EX or execute stage, the processor both decodes a shift amount associated with the shift/rotate instruction and actually performs, or executes, the shift operation. Next, in the write back (WB) stage, the processor writes the result of the shift/rotate operation to the register file. Ultimately, the processor may send the result to a main system memory for storage. In this conventional processor pipelining approach, the shift/rotate instruction requires several processor cycles to complete the execution of the instruction. The latency of the longest stage in the pipeline limits the execution speed of the processor. As seen in Table 1, since the EX execute stage of the pipeline includes both shift decode and shift execute, the EX execute stage limits the execution speed or frequency of the processor.

What is needed is a method and apparatus that executes shift/rotate instructions more quickly and efficiently.

### SUMMARY

Accordingly, in one embodiment, a method is disclosed for processing instructions in a processor The method includes receiving, by an instruction unit, an instruction stream including a plurality of instructions. The method also includes determining, by the instruction unit, if a shift/rotate instruction in the instruction stream is an immediate shift/rotate instruction or a register dependent shift/rotate instruction. The method still further includes immediately executing, by a shift/rotate functional unit, the shift/rotate instruction if the instruction unit determines that the shift/rotate instruction is an immediate shift/rotate instruction. The method also includes substituting, by the instruction unit, first and second substitute instructions in the instruction stream in place of the shift/rotate instruction if the instruction unit determines that the shift/rotate instruction is a register dependent shift/rotate instruction. The first substitute instruction instructs that a shift amount be stored in a shift amount register in the shift/rotate functional unit. The second substitute instruction instructs that the shift/rotate functional unit shift data by the shift amount stored in the shift amount register.

In another embodiment, a processor is disclosed that includes an instruction unit that receives an instruction stream including a plurality of instructions. The instruction unit determines if a shift/rotate instruction in the instruction stream is an immediate shift/rotate instruction or a register dependent shift/rotate instruction. The processor includes a shift/rotate functional unit, coupled to the instruction unit, that immediately executes the shift/rotate instruction if the instruction unit determines that the shift/rotate instruction is an immediate shift/rotate instruction. The instruction unit also includes a substitution apparatus that substitutes first and second substitute instructions in the instruction stream in place of the shift/rotate instruction if the instruction unit determines that the shift/rotate instruction is a register dependent shift/rotate instruction. The first substitute instruction instructs that a shift amount be stored in a shift amount register in the shift/rotate functional unit. The second substitute instruction instructs that the shift/rotate functional unit shift data by the shift amount stored in the shift amount register.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a conventional processor that executes shift/rotate instructions.

FIG. 2 shows a representation of an immediate shift/rotate instruction

FIG. 3 shows a representation of a register dependent shift/rotate instruction

FIG. 4 shows a block diagram of the disclosed processor.

FIG. 5A shows a substitute instruction.

FIG. 5B shows another substitute instruction.

FIG. 6 shows a flowchart that depicts process flow when the processor of FIG. 4 executes a shift/rotate instruction.

FIG. 7 shows a block diagram of an information handling system that includes the processor of FIG. 4.

### DETAILED DESCRIPTION

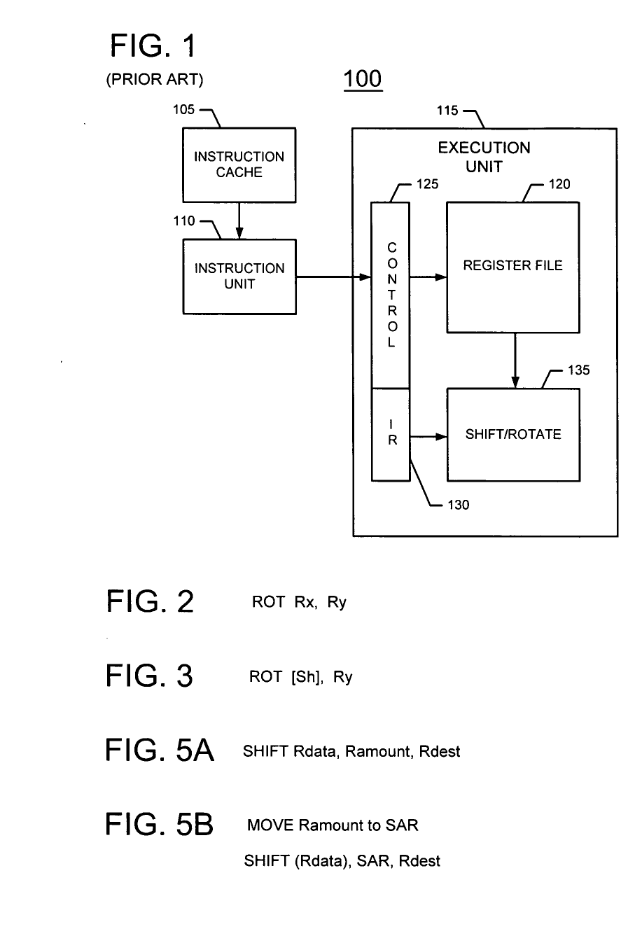

FIG. 1 shows a conventional processor 100 that includes an instruction cache 105 that stores recently accessed instructions in a software program. An instruction unit 110 couples to instruction cache 105 to receive an instruction stream therefrom. Instruction unit 110 decodes each instruction to determine an instruction's particular opcode, namely the function of each instruction, such as PUSH, POP and SHIFT/ROTATE for example. Instruction unit 110 couples to an execution unit 115 that executes instructions. More specifically, instruction unit 110 couples to a register file 120 in execution unit 115 via a control unit 125 therebetween. Control unit 125 controls operations in execution unit 115. Control unit 125 includes an instruction register 130 that supplies a SHIFT/ROTATE instruction from the instruction stream to a SHIFT/ROTATE functional unit 135 coupled to instruction register 130. In actual practice, processor 100 includes several functional units for executing instructions other than SHIFT/ROTATE. However, for simplicity, FIG. 1 only shows a SHIFT/ROTATE functional unit 135. SHIFT/ROTATE functional unit 135 couples to register file 120 so that register file 120 can receive and store results of SHIFT/ROTATE instructions that SHIFT/ROTATE functional unit 135 executes.

A ROTATE instruction is a type of SHIFT instruction typically in one of the forms shown in FIG. 2 and FIG. 3. FIG. 2 depicts a register dependent instruction in the form ROT Rx, Ry wherein ROT is a ROTATE opcode, Rx is the shift amount and Ry specifies the destination register where processor 100 stores the result of the ROTATE instruction. Execution of this instruction depends on accessing a register, Rx, in register file 120 that contains the shift amount. For this reason, the FIG. 2 type of ROTATE instruction defines a register dependent SHIFT/ROTATE instruction.

FIG. 3 depicts an immediate SHIFT/ROTATE instruction in the form ROT [Sh], Ry wherein the SHIFT/ROTATE instruction itself contains a constant value, [Sh], defining the shift amount. Ry defines the destination register in register file 120 where the processor stores the result of the immediate SHIFT/ROTATE instruction.

In one conventional processor 100, the processor decodes a SHIFT/ROT instruction and executes the SHIFT/ROT instruction in the same pipeline stage. More particularly, as seen in TABLE 1 above, the processor reads operands from the register file in the RF stage of the pipeline. Then, in the next processor cycle, the processor both decodes the SHIFT/ROTATE instruction to determine the shift amount and executes the instruction. The decoding and execution occur in the same pipeline stage, namely the EX execute stage. Decoding and execution represent serial tasks in that the processor performs one before the other, thus resulting in a lengthy EX execute pipeline stage that limits processor performance. In other words, in this approach the processor serializes the decoding and shifting.

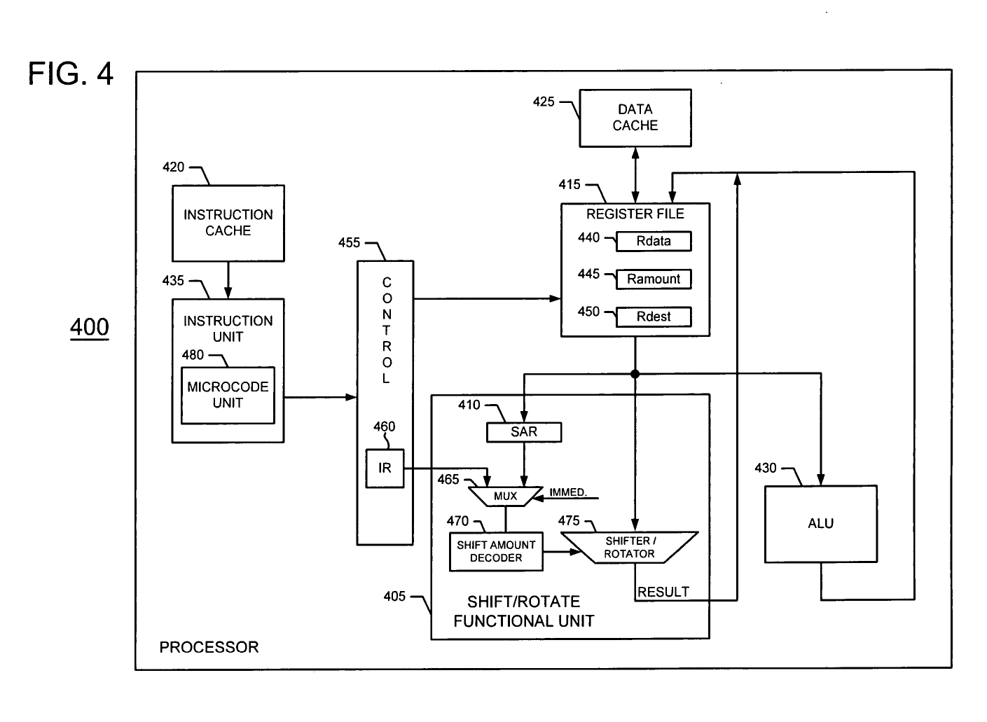

The disclosed processor 400 of FIG. 4 employs an improved pipeline for handling the immediate SHIFT/ROT instructions depicted in FIG. 3. TABLE 2 below shows the improved pipeline for immediate SHIFT/ROT instructions.

TABLE 2

| Pipeline Stage | Action |
|---|---|
| ISS | Receive Instruction (issue) |
| RF | Read operands from register file, |
| | decode shift amount specified within |
| | the instruction |
| EX | Perform shift (execute) |
| WB | Result available (write back) |

This pipeline enables immediate SHIFT/ROT instructions to execute more quickly than the conventional pipeline of TABLE 1. In this embodiment, the processor decodes the shift amount of immediate SHIFT/ROT instructions in the pipeline stage before the EX execute stage, namely in the RF register file stage. Thus, the processor is ready to execute the immediate SHIFT/ROT instruction when the processor reaches the EX execute stage without waiting for decoding in that stage. Processor 400 may perform the decoding task in the RF register file pipeline stage in parallel with other tasks.

Processor 400 can also handle register dependent SHIFT/ROTATE instructions depicted in FIG. 2. To handle these instructions, processor 400 employs a shift amount register (SAR) 410. Processor 400 updates shift amount register 410 with decoded shift amount information from register file 415. For register dependent SHIFT/ROT instructions, processor 400 uses the shift amount stored in SAR 410 to perform the SHIFT/ROT instruction. However, for immediate SHIFT/ROT instructions, processor 400 uses the shift amount specified by the immediate SHIFT/ROT instruction itself. This enables immediate SHIFT/ROT instructions to execute more quickly.

In more detail, processor 400 includes an instruction cache 420 and a data cache 425. Instruction cache 420 stores instructions from a software program that processor 400 executes. Data cache 410 stores data that processor 400 requires to execute instructions. Processor 400 includes functional units such as an arithmetic logic unit (ALU) 430 that performs arithmetic operations such as ADD and SUBTRACT. Processor 400 also includes a SHIFT/ROTATE functional unit or engine 405 that performs shift and a rotate operations. Processor 400 may include other functional units, such as load and store functional units (not shown), for example.

Instruction cache 420 couples to an instruction unit 435 that decodes instructions in an instruction stream that it receives from instruction cache 420. Processor 400 handles register dependent SHIFT/ROT instructions in a different manner than immediate SHIFT/ROT instructions. FIG. 5A shows the format of a register dependent SHIFT instruction that processor 400 can execute as SHIFT Rdata, Ramount, Rdest, wherein SHIFT is the opcode and Rdata, Ramount and Rdest are operands. The SHIFT opcode instructs the processor to execute a shift operation, in this instance, a register dependent shift. Rdata defines the data in a particular data field of predetermined width. Ramount defines the amount of the shift, i.e. the number of bits by which to shift. Rdest defines the destination where processor 400 should place the result in register file 415. Processor 400 stores Rdata, Ramount and Rdest in respective registers in register file 415. More specifically, register file 415 includes an Rdata register 440 to store the Rdata on which the SHIFT operation should operate. Register file 415 also includes an Ramount register 445 to store the amount of the requested shift, namely the shift amount. Register file 415 further includes an Rdest register 450 where the SHIFT/ROTATE engine 415 stores the result of the requested shift operation.

A control unit 455 couples instruction unit 435 to SHIFT/ROTATE functional unit 405 and register file 415 as shown. Control unit 455 controls the processes carried out by SHIFT/ROTATE engine 405 and register file 415 in the course of executing SHIFT/ROTATE instructions. Control unit 455 includes an instruction register 460 that provides a decoded SHIFT/ROTATE instruction to functional unit 405.

SHIFT/ROTATE functional unit 405 includes the shift amount register (SAR) 410 that stores the shift amount, namely Ramount, specified by a register dependent SHIFT/ROTATE instruction that processor 400 executes. When processor 400 encounters such a register dependent SHIFT/ROTATE instruction, instruction unit 435 decodes the shift amount as a quantity stored at a location in register file 415, namely the Ramount register 445 therein. In response to a request by control unit 455, processor 415 sends the contents of Ramount register 445 to shift amount register (SAR) 410. Thus, SAR 410 stores the shift amount needed by register dependent SHIFT/ROTATE instructions while instruction register 460 stores the shift amount specified by immediate SHIFT/ROTATE instructions, namely the shift amount contained within the instruction itself. The IMMED signal applied to the IMMED input of multiplexer 465 determines whether multiplexer (MUX) 465 sends the shift amount in SAR 410 to shift amount decoder 470 or the shift amount from instruction register 460 to shift amount decoder 470. Shift amount decoder 470 couples MUX 465 to shifter/rotator 475. Shifter/rotator 475 shifts the data stored in a data field specified by a SHIFT/ROTATE instruction by an amount that shift amount decoder specifies to shifter/rotator 475. Shifter/rotator 475 sends the result of the shift operation to register file 415 for storage at a destination such as destination register Rdest 450.

The following describes the operation of processor 400 when processor 400 encounters an immediate SHIFT/ROTATE instruction in the instruction stream provided by instruction cache 420. When instruction unit 435 receives and decodes such an immediate SHIFT/ROTATE instruction, processor 400 enters an immediate mode of operation for that instruction. More particularly, a microcode unit 480 in instruction unit 435 monitors the instructions in the instruction stream to locate any register dependent SHIFT/ROTATE instructions. When microcode unit 480 locates a register dependent SHIFT/ROTATE instruction, processor 400 enters a register dependent mode of operation for that instruction. In actual practice, processor 400 may operate in both immediate mode and register dependent mode concurrently in the sense that pipeline stages of each mode may overlap.

However, when instruction unit 435 receives an immediate SHIFT/ROTATE instruction such as that of FIG. 3, processor 400 commences an immediate mode for that instruction. In this immediate mode during the ISS issue pipeline stage, control unit 455 decodes the immediate SHIFT/ROTATE instruction and places the shift amount obtained directly from the instruction into instruction register 460. During the RF register file pipeline stage in the immediate mode, control unit 455 raises the IMMED control input of MUX 465 high to select the MUX input that couples to instruction register 460. In this manner, MUX 470 sends the shift amount [Sh] from instruction register 460 to shift amount decoder 470. Shift amount decoder 470 decodes the shift amount into the number of bits that shift/rotate unit 475 needs to shift to carry out the current immediate SHIFT/ROTATE instruction. Then during the EX execution pipeline stage, shifter/rotator 475 shifts data in the specified data field by the amount of the number of bits that shift decoder indicates. Shifter/rotator 475 then sends the result of the immediate SHIFT/ROTATE operation to register file 415 for storage during the WB write back pipeline stage. In this manner, when operating in immediate mode, processor 400 implements the pipeline depicted in TABLE 2 to speed up the execution of immediate SHIFT/ROTATE instructions.

In contrast, the following describes the operation of processor 400 when processor 400 encounters a register dependent SHIFT/ROTATE instruction in the instruction stream provided by instruction cache 420. When instruction unit 435 encounters a register dependent SHIFT/ROTATE instruction, processor 400 enters a register dependent mode. Programming in microcode unit 480 monitors the instruction stream passing through instruction unit 435. When microcode unit 480 encounters a register dependent instruction such as the SHIFT Rdata, Ramount, Rdest instruction depicted in FIG. 5A, microcode unit 480 effectively intercepts that instruction and in its place substitutes the two instructions depicted in FIG. 5B. In this manner, microcode unit 480 acts as an instruction substitution apparatus. More particularly, microcode unit 480 substitutes a MOVE Ramount to SAR instruction in the instruction stream and a SHIFT (Rdata), SAR, Rdest instruction into the instruction stream as well. In actual practice, microcode unit 480 detects the register dependent SHIFT/ROTATE instruction prior to the ISS stage in the TABLE 2 pipeline. The first substitute instruction, namely the MOV Ramount to SAR instruction, is an unarchitected instruction that causes the processor to move the shift amount, Ramount, from Ramount register 445 in register file 415 to shift amount register (SAR) 410.

When microcode unit 480 intercepts a register dependent SHIFT/ROTATE instruction and processor 400 enters register dependent mode, control unit 455 causes the IMMED signal to go low to instruct MUX 465 to send the shift amount, Ramount, stored in SAR 410 to shift amount decoder 470. The second substitute instruction, namely SHIFT (Rdata), SAR, Rdest now executes because all information needed to execute the instruction is known and available. Register file 415 provides the data to be shifted/rotated from Rdata register 440 to shifter/rotator 475. Execution of the first substitute instruction already moved the shift amount, Ramount, to shifter/rotator 475. Register file 415 also provides the destination register, Rdest 450 to shifter/rotator 475 so that shifter/rotator 475 knows the destination in which to store the results of the SHIFT/ROTATE instruction. When the second substitute instruction executes, register file 415 stores the result of the shift operation in the Rdest destination register 450.

Once the first substitute instruction of FIG. 5A executes to load SAR 410 with the shift amount of a register dependent SHIFT/ROTATE instruction, the shift amount in SAR 410 is valid and ready for selection for shift amount decode during the register file (RF) stage of the TABLE 2 pipeline. With all second substitute instruction operands as well as the opcode thus being known, shifter/rotator 475 stands ready to execute the second substitute instruction of FIG. 5B. Shifter/rotator 475 then executes the second substitute instruction of FIG. 5B and sends the result to register file 415. Register file 415 stores the result in destination register Rdest 450. Processor 400 does not require one execute cycle to find the shift amount of a register dependent ROTATE/SHIFT instruction and then a second execute cycle to actually carry out the shift operation. Rather, in one embodiment, the execution of SHIFT/ROTATE instructions completes in a single execution (EX) cycle of the pipeline. For register dependent SHIFT/ROTATE instructions, once the first substitute instruction completes, the second substitute instruction goes through the same pipeline stages as an immediate SHIFT/ROTATE instruction, except that during the RF pipeline stage, shift amount register (SAR) 410 provides the shift amount rather than instruction register (IR) 460.

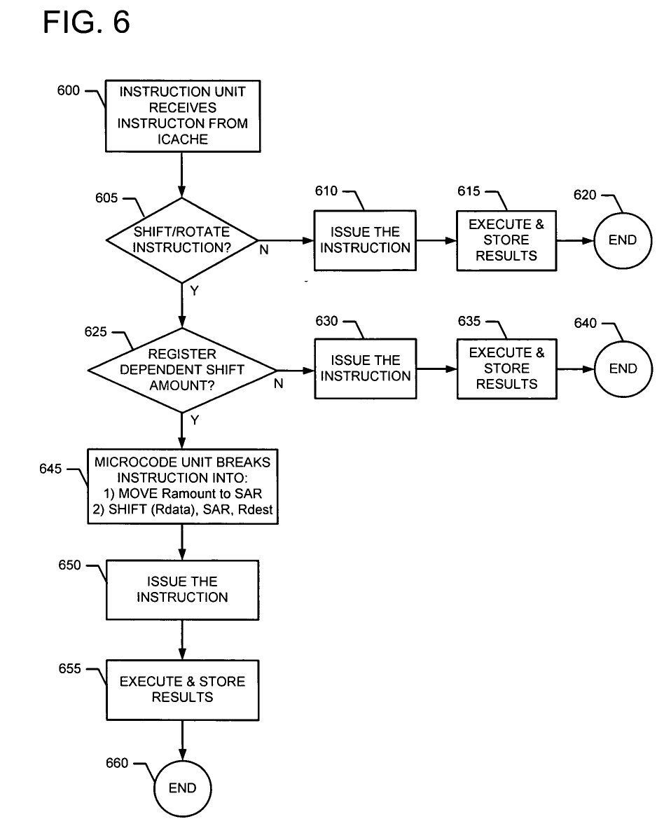

FIG. 6 shows a flowchart that describes process flow in processor 400 when executing a SHIFT/ROTATE instruction. Instruction unit 435 receives instructions from instruction cache 420, as per block 600. Instruction unit 435 decodes instructions in the instruction stream provided by instruction cache 420. Instruction unit 435 determines if the current instruction passed to instruction unit 435 is a shift/rotate instruction, as per block 605. If an instruction in the instruction stream is not a shift/rotate instruction, then control unit 455 sends such an instruction to an appropriate functional unit, for example ALU 430, for execution as per block 610. The appropriate functional unit then executes the instruction and stores the results in register file 415, as per block 615. In a simplified case, the process ends at end block 620. However, in actual practice, process flow may continue back to block 600 that processes the next instruction in the instruction stream.

If decision blocks 605 determines that the current instruction is a shift/rotate instruction, then process flow continues to decision block 625. At decision block 625, microcode unit 480 in instruction unit 435 performs a test to determine if the current instruction is a register dependent shift/rotate instruction. In other words, microcode unit 480 performs a test to determine if the current shift/rotate instruction is an instruction that involves a register dependent shift amount. If microcode unit 480 determines that the current shift/rotate instruction does not involve a register dependent shift amount, then that instruction is an immediate shift/rotate instruction. In this event, processor 400 operates in an immediate mode wherein instruction unit 435 issues the immediate shift/rotate instruction, as per block 630, for immediate execution. Shift/rotate engine 405 then executes the instruction and stores the results in register file 415, as per block 635. In a simplified case, the process ends at end of block 640. However, in actual practice, process flow may continue back to block 600 that processes the next instruction in the instruction stream.

Microcode unit 480 of instruction unit 435 continues to monitor the instruction stream for register dependent shift/rotate instructions, as per decision block 625. When decision block 625 finds such a register dependent shift/rotate instruction, then processor 400 operates in a register dependent mode wherein microcode unit 480 breaks the register dependent instruction into a first substitute instruction and a second substitute instruction, as per block 645. More particularly, microcode unit 480 breaks the instruction into a first substitute instruction, MOVE Ramount to SAR that retrieves and moves the shift amount specified in the Ramount register 445 in the register file 415 to the special shift amount register (SAR) 410. Microcode unit 480 also breaks the instruction into a second substitute instruction, SHIFT (Rdata), SAR, Rdest. Then, instruction unit 435 issues the second substitute instruction, SHIFT (Rdata), SAR, Rdest, to SHIFT/ROTATE functional unit 405, as per block 650. In response, SHIFT/ROTATE functional unit 405 executes the second substitute instruction to shift the data in the data field, Rdata, by the amount specified in the shift amount register (SAR) 410, as per block 655. SHIFT/ROTATE functional unit 405 provides the result to destination register Rdest 450 when shifter/rotator 475 executes the second substitute instruction, also as per block 655. In a simplified case, process flow ends at end block 660. However, in actual practice, process flow may continue back to block 600 at which the instruction unit 435 continues processing instructions from the instruction cache 420.

While in the embodiment discussed above, microcode unit 480 monitors the instruction stream for immediate SHIFT/ROTATE instructions and register dependent SHIFT/ROTATE instructions, in another embodiment a portion of the instruction unit 435 external to the microcode unit 480 may monitor the instruction stream for such instructions. However, in that embodiment, once the instruction unit locates such a register dependent SHIFT/ROTATE instruction, then microcode unit 480 performs the function of breaking the register dependent instruction into the first and second substitute instructions depicted in FIG. 5A and FIG. 5B and discussed above.

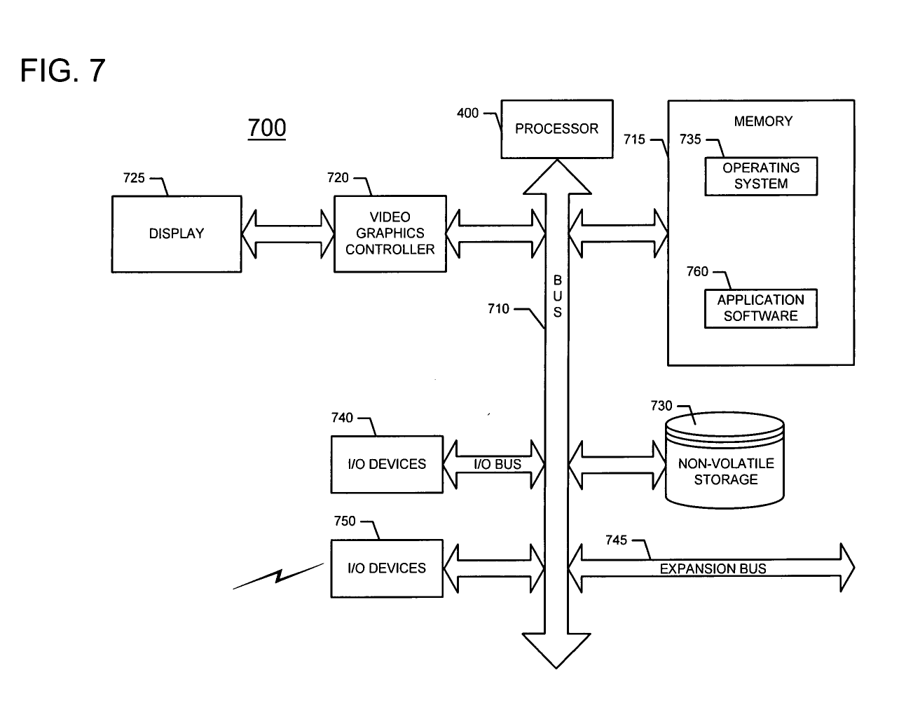

FIG. 7 shows an information handling system (IHS) 700 that includes processor 400. IHS 700 further includes a bus 710 that couples processor 400 to system memory 715 and video graphics controller 720. A display 725 couples to video graphics controller 720. Nonvolatile storage 730, such as a hard disk drive, CD drive, DVD drive, or other nonvolatile storage couples to bus 710 to provide IHS 700 with permanent storage of information. An operating system 735 loads in memory 715 to govern the operation of IHS 700. I/0 devices 740, such as a keyboard and a mouse pointing device, couple to bus 710. One or more expansion busses 745, such as USB, IEEE 1394 bus, ATA, SATA, PCI, PCIE and other busses, couple to bus 710 to facilitate the connection of peripherals and devices to IHS 700. A network adapter 750 couples to bus 710 to enable IHS 700 to connect by wire or wirelessly to a network and other information handling systems. While FIG. 7 shows one IHS that employs processor 400, the IHS may take many forms. For example, IHS 700 may take the form of a desktop, server, portable, laptop, notebook, or other form factor computer or data processing system. IHS 700 may take other from factors such as a personal digital assistant (PDA), a gaming device, a portable telephone device, a communication device or other devices that include a processor and memory.

The foregoing discloses a processor that may provide improved efficiency in processing immediate and register dependent shift rotate instructions.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

1. A method of processing instructions in a processor, the method comprising:
receiving, by an instruction unit, an instruction stream including a plurality of instructions;
determining, by the instruction unit, if a shift/rotate instruction in the instruction stream is an immediate shift/rotate instruction or a register dependent shift/rotate instruction;
immediately executing, by a shift/rotate functional unit, the shift/rotate instruction if the instruction unit determines that the shift/rotate instruction is an immediate shift/rotate instruction; and
substituting, by the instruction unit, first and second substitute instructions in the instruction stream in place of the shift/rotate instruction if the instruction unit determines that the shift/rotate instruction is a register dependent shift/rotate instruction, the first substitute instruction instructing that a shift amount be stored in a shift amount register in the shift/rotate functional unit, the second substitute instruction instructing that the shift/rotate functional unit shift data by the shift amount stored in the shift amount register.

2. The method of claim 1, further comprising executing, by the shift/rotate functional unit, the first substitute instruction to move the shift amount from a register file to the shift amount register in the shift/rotate functional unit.

3. The method of claim 2, further comprising executing, by the shift/rotate functional unit, the second substitute instruction to shift data as specified by the shift amount stored in the shift amount register, thus providing a result.

4. The method of claim 3, further comprising storing the result of executing the second substitute instruction in a destination register in the register file of the processor.

5. The method of claim 1, further comprising decoding in a first pipeline stage, by the instruction unit, a shift amount within a shift/rotate instruction when the instruction unit determines the shift/rotate instruction to be an immediate shift/rotate instruction.

6. The method of claim 5, wherein the immediately executing step is performed by the shift/rotate functional unit in a second pipeline stage following the first pipeline stage.

7. The method of claim 1, further comprising decoding, by a shift amount decoder in the shift/rotate functional unit, a shift amount from the shift amount register in the shift/rotate functional unit if the instruction unit determines that the shift/rotate instruction is a register dependent shift/rotate instruction, the instruction unit being in a first pipeline stage, and executing the second substitute instruction by the shift/rotate functional unit in a second pipeline stage following the first pipeline stage.

8. A processor comprising:
an instruction unit that receives an instruction stream including a plurality of instructions and that determines if a shift/rotate instruction in the instruction stream is an immediate shift/rotate instruction or a register dependent shift/rotate instruction; and
a shift/rotate functional unit, coupled to the instruction unit, that immediately executes the shift/rotate instruction if the instruction unit determines that the shift/rotate instruction is an immediate shift/rotate instruction;
the instruction unit including a substitution apparatus that substitutes first and second substitute instructions in the instruction stream in place of the shift/rotate instruction if the instruction unit determines that the shift/rotate instruction is a register dependent shift/rotate instruction, the first substitute instruction instructing that a shift amount be stored in a shift amount register in the shift/rotate functional unit, the second substitute instruction instructing that the shift/rotate functional unit shift data by the shift amount stored in the shift amount register.

9. The processor of claim 8, further comprising a register file coupled to the shift/rotate functional unit, wherein the shift/rotate functional unit executes the first substitute instruction to move the shift amount from the register file to the shift amount register in the shift/rotate functional unit.

10. The processor of claim 9, wherein the shift/rotate functional unit executes the second substitute instruction to shift data as specified by the shift amount stored in the shift amount register, thus providing a result.

11. The processor of claim 10, wherein the shift/rotate functional unit stores the result of executing the second substitute instruction in a destination register in the register file of the processor.

12. The processor of claim 8, wherein the instruction unit decodes in a first pipeline stage a shift amount within a shift/rotate instruction when the instruction unit determines the shift/rotate instruction to be an immediate shift/rotate instruction.

13. The processor of claim 12, wherein the shift/rotate functional unit executes the immediate shift/rotate instruction in a second pipeline stage following the first pipeline stage.

14. The processor of claim 8, further comprising a register file coupled to the shift/rotate functional unit, the register file including a data register that stores the data to be shifted by the shift/rotate instruction.

15. An information handling system (IHS) comprising:
a processor including:
an instruction unit that receives an instruction stream including a plurality of instructions and that determines if a shift/rotate instruction in the instruction stream is an immediate shift/rotate instruction or a register dependent shift/rotate instruction;
a shift/rotate functional unit, coupled to the instruction unit, that immediately executes the shift/rotate instruction if the instruction unit determines that the shift/rotate instruction is an immediate shift/rotate instruction;
the instruction unit including a substitution apparatus that substitutes first and second substitute instructions in the instruction stream in place of the shift/rotate instruction if the instruction unit determines that the shift/rotate instruction is a register dependent shift/rotate instruction, the first substitute instruction instructing that a shift amount be stored in a shift amount register in the shift/rotate functional unit, the second substitute instruction instructing that the shift/rotate functional unit shift data by the shift amount stored in the shift amount register; and
a memory coupled to the processor.

16. The IHS of claim 15, wherein the shift/rotate functional unit executes the first substitute instruction to move the shift amount from a register file to the shift amount register in the shift/rotate functional unit.

17. The IHS of claim 16, wherein the shift/rotate functional unit executes the second substitute instruction to shift data as specified by the shift amount stored in the shift amount register, thus providing a result.

18. The IHS of claim 15, wherein the instruction unit decodes in a first pipeline stage a shift amount within a shift/rotate instruction when the instruction unit determines the shift/rotate instruction to be an immediate shift/rotate instruction.

19. The IHS of claim 18, wherein the shift/rotate functional unit executes the immediate shift/rotate instruction in a second pipeline stage following the first pipeline stage.
